(19) United States
(12) Patent Application Publication
(10) Pub. No.: US 2012/0166349 A1
(43) Pub. Date: Jun. 28, 2012

(54) SOCIAL MEDIA COMMUNICATION AND RELATIONSHIP MANAGEMENT

(76) Inventors: Anastasia Dedis, Lutz, FL (US); Panos E. Kontses, Lutz, FL (US)

(21) Appl. No.: 12/980,058

(22) Filed: Dec. 28, 2010

(51) Int. Cl. G06Q 99/00; G06F 15/16

(52) U.S. Cl. 705/319; 709/204

(57) ABSTRACT

An apparatus, system, and method and for social media communication and relationship management. The method includes providing a user with a user account on a web-based social networking platform. The user may own user content associated with the user account and the user content may be stored by the social networking platform. The method may also include charging one or more commercial entities in response to brokering communication between the one or more commercial entities and the user through the social networking platform.

### FIELD

The subject matter of the present application relates to web-based social networking and more particularly relates to social media communication and relationship management on a web-based social networking platform.

### BACKGROUND

The Internet has given rise to web-based social networking. A user may, through a social networking platform, maintain connections with friends, communicate with these friends, post electronic media such as photos and videos, and the like. However, the user's electronic media becomes the property of the social networking platform and may be subject to deletion, unwanted sharing, and the like. Furthermore, by default, the information posted for contacts of the user is typically viewable by the user's contacts, which may include individuals with varying relationships to the user such as social, professional, and the like. Therefore, information about a user may reach unintended individuals of the user's contacts.

Moreover, a user typically maintains accounts with multiple social networking platforms, each with its own focus such as social, professional, public, and the like. As a result, the user has to manage multiple accounts, multiple passwords, and redundant contact lists.

### SUMMARY

From the foregoing discussion, it should be apparent that a need exists for an apparatus, system, and method that consolidate various areas of social networking and that allow a user greater control over user content. Beneficially, such an apparatus, system, and method would aggregate multiple networking environments and allow a user to own user content.

Accordingly, the present disclosure has been developed in response to the present state of the art, and in particular, in response to the problems and needs in the art that have not yet been fully solved by currently available social networking platforms. Accordingly, the subject matter described herein has been developed to provide an apparatus, system, and method that overcome many or all of the above-discussed shortcomings in the art.

A method is provided for social media communication and relationship management. The method includes providing a user with a user account on a web-based social networking platform. The user may own user content associated with the user account and the user content may be stored by the social networking platform. The method may also include charging one or more commercial entities in response to brokering communication between the one or more commercial entities and the user through the social networking platform.

In one embodiment, the user account is provided free of charge to the user. The method may further include establishing a payment policy that includes associating the user account with a sponsor. The sponsor may pay a maintenance cost of the user account on the social networking platform and the user account may be maintained free of additional advertisements and/or malicious software. In one embodiment, the user account is provided free of charge to the user. The method may further include establishing a payment policy wherein the social networking platform pays a maintenance cost of the user account on the social networking platform.

In one embodiment, the method further includes establishing a payment policy wherein the user pays a maintenance cost of the user account on the social networking platform, the user account maintained free of advertisements and/or malicious software. In some embodiments, the method includes brokering communication between the one or more commercial entities and the user through the social networking platform. Brokering communication may include facilitating communication channel formation between the user and the one or more commercial entities. Brokering communication may also include transmitting electronic messages between the user and the one or more commercial entities over one or more communication channels. Furthermore, brokering communication may also include facilitating unsolicited communication from the one or more commercial entities to the user.

In one embodiment, charging one or more commercial entities in response to brokering communication further includes charging commercial entities per communication with the user, charging commercial entities a monthly participation fee, charging commercial entities per communication channel, charging commercial entities for creating a communication channel from search results, and/or charging commercial entities for optimizing search results.

In one embodiment, the method includes managing an ombudsman service tracking complaints, complaint resolutions, and/or user reviews for a plurality of commercial entities on the social networking platform.

In one embodiment, the method includes combining a plurality of communication environments in association with the user account on the web-based social networking platform. Each communication environment may include a communication stream, a plurality of user contacts, and a plurality of communication channels. The method may include insulating a first communication environment of the plurality of communication environments from one or more second communication environments. The method may also include representing the plurality of communication environments on a user suite. The user suite may include a consolidated network webpage on the web-based networking platform for the user account.

In one embodiment, representing the plurality of communication environments on the user suite further includes representing the plurality of communication environments with a plurality of environment interfaces. Each communication environment may be represented with a distinct environment interface. Representing the plurality of communication environments may further include aggregating the plurality of environment interfaces on the user suite.

In one embodiment, a particular environment interface includes a first visual representation of the communication stream, a second visual representation of the plurality of user contacts, and a third visual representation of the plurality of communication channels. In some embodiments, the method includes communicating a plurality of electronic messages over the plurality of communication channels of a particular communication environment. The method may also include representing the plurality of electronic messages in a particular environment interface for the particular communication environment and sorting the plurality of represented electronic messages by one or more of communication channel, date, and user contact photo as specified by the user.

In one embodiment, the method includes changing the appearance of the user suite based on a viewer identity. In certain embodiments, the method includes combining a second plurality of communication environments in association with a commercial entity account on the web-based social networking platform. Each communication environment of the second plurality of communication environments may include a communication stream, a plurality of connections, commercial entity contacts, and a plurality of communication channels. The method may also include representing the second plurality of communication environments on a commercial entity stage. The commercial entity stage may include a consolidated network webpage on the web-based networking platform for the commercial entity account.

In one embodiment, the method includes communicating a user review notification from the social networking platform to an add-on in an Internet browser of the user. The user review notification may include at least a notification of user review information. The add-on may alert the user in response to the user viewing a particular webpage on the Internet browser. The particular webpage may be associated with an entity corresponding to the user review information, which may be stored on the social networking platform.

In one embodiment, the method includes backing-up the user content stored on the social networking platform to a user storage device. The method may also include uploading backed-up user content from the user storage device and restoring user content to the user account from the backed-up user content.

An apparatus is also provided for social media communication and relationship management. The apparatus may include modules configured to carry out at least a portion of the steps of the method. A computer program product is also presented for social media communication and relationship management. The computer program product may be configured to carry out at least a portion of the steps of the method.

Another embodiment of a method is provided for social media communication and relationship management. The method includes providing a user with a user account on a web-based social networking platform. The user account may include a portion of the social networking platform. The user account may include capacity to store user content on the social networking platform. The method includes granting ownership of the user account and associated user content in exchange for the user improving the social networking platform.

In one embodiment, the user account is provided free of charge to the user. The method further includes associating the user account with a sponsor. The sponsor may pay a maintenance cost of the user account on the social networking platform and the user account may be maintained free of one or more of additional advertisements and malicious software.

In one embodiment, the user account is provided free of charge to the user and the method further includes paying at least a portion of a maintenance cost of the user account on the social networking platform. The user account may be maintained free of one or more of advertisements and malicious software. In one embodiment, the user pays a maintenance cost of the user account on the social networking platform and the user account maintained free of one or more of advertisements and malicious software. In one embodiment, the method includes charging one or more commercial entities in response to brokering communication between the one or more commercial entities and the user through the social networking platform.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the features, advantages, and characteristics of the subject matter described herein may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

### BRIEF DESCRIPTION OF THE DRAWINGS

The appended drawings depict embodiments of the subject matter disclosed herein and are not therefore to be considered to be limiting of its scope, the subject matter will be described and explained with additional specificity and detail through the use of the accompanying drawings, in which:

FIG. 1 is a schematic block diagram illustrating one embodiment of a system for social media communication and relationship management;

FIG. 2 is a detailed schematic block diagram illustrating another embodiment of a system for social media communication and relationship management;

FIG. 3A is a schematic block diagram illustrating one embodiment of an apparatus for social media communication and relationship management;

FIG. 3B is a schematic block diagram illustrating another embodiment of an apparatus for social media communication and relationship management;

FIG. 3C is a schematic block diagram illustrating another embodiment of an apparatus for social media communication and relationship management;

FIG. 4 is a detailed schematic flow chart diagram illustrating yet another embodiment of an apparatus for social media communication and relationship management;

FIG. 5 illustrates one embodiment of a user suite with a plurality of communication environments;

FIG. 6A illustrates one embodiment of a visual representation of a communication stream of a public environment;

FIG. 6B illustrates one embodiment of a visual representation of a communication stream of a social environment;

FIG. 6C illustrates one embodiment of a visual representation of a communication stream of a commercial environment;

FIG. 6D illustrates one embodiment of a visual representation of a communication stream of a professional environment;

FIG. 7A illustrates one embodiment of a visual representation of a message box of a public environment;

FIG. 7B illustrates one embodiment of a visual representation of a message box of a social environment;

FIG. 7C illustrates one embodiment of a visual representation of a message box of a commercial environment;

FIG. 7D illustrates one embodiment of a visual representation of a message box of a professional environment;

FIG. 8A illustrates one embodiment of a visual representation of a following interface of a public environment;

FIG. 8B illustrates one embodiment of a visual representation of a followers interface of a public environment;

FIG. 9A illustrates one embodiment of a visual representation of a connections interface of a social environment;

FIG. 9B illustrates one embodiment of a visual representation of a connections interface of a commercial environment;

FIG. 9C illustrates one embodiment of a visual representation of a connections interface of a professional environment;

FIG. 10 illustrates one embodiment of a visual representation of a rewards interface of a commercial environment;

FIG. 11 illustrates one embodiment of a visual representation of a jobs interface of a professional environment;

FIG. 12 illustrates one embodiment of an entity stage with a plurality of communication environments;

FIG. 13 is a schematic flow chart diagram illustrating one embodiment of a method for social media communication and relationship management;

FIG. 14 is a detailed schematic flow chart diagram illustrating another embodiment of a method for social media communication and relationship management;

FIG. 15 is a schematic flow chart diagram illustrating another embodiment of a method for social media communication and relationship management;

FIG. 16 is a detailed schematic flow chart diagram illustrating another embodiment of a method for social media communication and relationship management;

FIG. 17 is a schematic flow chart diagram illustrating one embodiment of a method for backing-up user content for a social networking platform; and

FIG. 18A is a schematic flow chart diagram illustrating another embodiment of a method for social media communication and relationship management; and

FIG. 18B is a schematic flow chart diagram illustrating another embodiment of a method for social media communication and relationship management.

### DETAILED DESCRIPTION

As will be appreciated by one skilled in the art, aspects of the present subject matter may be embodied as a system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the subject matter described herein may be written in any combination of one or more programming languages, including an object oriented programming language such as Java, Smalltalk, C++ or the like and conventional procedural programming languages, such as the “C” programming language or similar programming languages, and scripting languages such as Flash Action Script, PHP, JavaScript, Ruby and AJAX. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the subject matter described herein. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

Aspects of the present subject matter are described below with reference to schematic flowchart diagrams and/or schematic block diagrams of methods, apparatuses, systems, and computer program products according to embodiments of the subject matter. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present subject matter. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

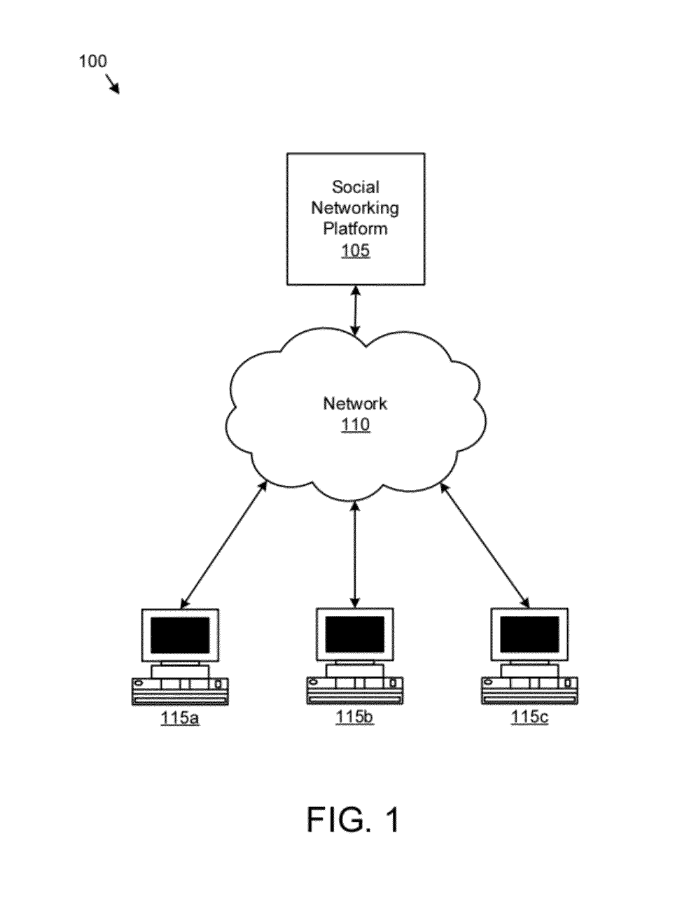

FIG. 1 depicts one embodiment of a system 100 for social media communication and relationship management. The system 100 includes a social networking platform 105, a network 110, and a plurality of clients 115. The social networking platform 105 may host, store, include and/or provide web-based social networking and/or a web-based social networking website for access over the network 110 by the plurality of clients 115. The social networking platform 105 may include and/or be implemented by servers, storage, databases and other infrastructure. One or more servers comprising the social networking platform 105 may be embodied as a computing device including a desktop computer, a portable computer, a server, a mainframe computer, and the like. The one or more servers may include memory storing computer readable programs and may include a processor that executes the computer readable programs as is well known to those skilled in the art. The computer readable programs may be tangibly stored in storage in communication with the server one or more servers. The one or more servers may host, store, and/or provide the social networking website for access, and/or download over the network 110 by the plurality of clients 115 as is known in the art.

References herein to the social networking platform 105 may also include references to one or more businesses, organizations, and/or personnel that host, support, provide, and/or operate the social networking website. Moreover, the social networking platform 105 may, in certain embodiments, be similar to and/or share at least a portion of the functions of the social networking platform 105 described in United States patent application entitled “Social Media Communication and Contact Organization,” Attorney docket number 2746.2.3, filed on Dec. 28, 2010 for Anastasia Dedis et al. (hereinafter the “Other application”), which is incorporated herein by reference.

The network 110 may comprise a global communications network such as the Internet, a Local Area Network (LAN), multiple LANs communicating over the internet, or any other similar communications network. Each client 115 may be embodied as a desktop computer, a portable computer, a server, a mainframe computer, a handheld computing device, a touch device, a personal desktop assistant (“PDA”), a tablet computer, an eBook reader, a mobile phone, a Smartphone, and the like.

Each client 115 may communicate with the social networking platform 105 through the network 110. In one embodiment, a client 115 communicates with the social networking platform 105 by way of an application, such as an Internet browser, executing on the client 115 and accesses and/or downloads web pages of the social networking website as is known in the art.

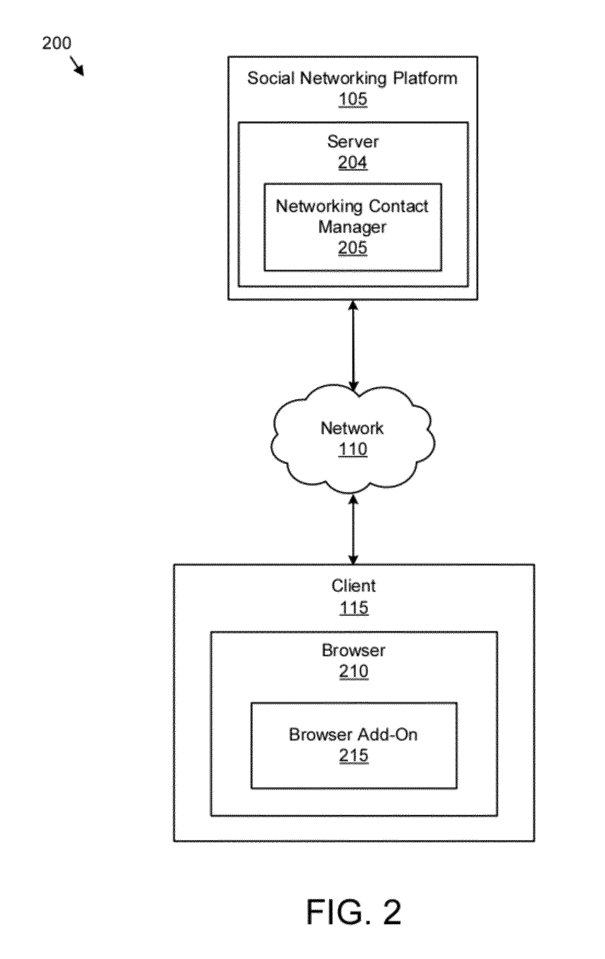

FIG. 2 depicts a detailed embodiment of a system 200 for social media communication and relationship management. The description of the system 200 refers to elements of FIG. 1, like numbers referring to like elements. The system 200 includes a social networking platform 105 that may be substantially similar to the social networking platform 105 depicted in FIG. 1. Moreover, the system 200 may, in certain embodiments, be similar to and/or share at least a portion of the functions of the system 200 described in the Other application.

The social networking platform 105 includes a server 204 social networking manager 205. Furthermore, the social networking manager 205 may be similar to and/or share at least a portion of the functions and/or modules of the networking contact manager 205 described in the Other application. While the server 204, in the depicted embodiment, includes the social networking manager 205, in certain embodiments, all or a portion of the social networking manager 205 may reside and/or be embodied outside the server and/or on multiple servers. The social networking platform 105 is in communication with a network 110 in communication with a client 115. The network 110 and the client 115 may be substantially similar to the like numbers elements in FIG. 1. Furthermore, the client 115 includes a browser 210 with a browser add-on 215. The browser 210 may be embodied as an application configured to present, access and/or download web pages as is known in the art. In one embodiment, the browser add-on 215 may be similar to and/or share at least a portion of the functions and/or modules of the browser add-on 215 described in the Other application.

The social networking manager 205 may host, server, and/or include all or a portion of a social networking website. Furthermore, the social networking website may be embodied as one or more web pages available for access over the network 110. Each web page may include software code, images, and text as is known in the art. Specifically, each web page may include static and/or dynamic elements and include Hypertext Markup Language (“HTML”) code, JavaScript code, Flash animations, and the like. The following description refers to a single user; however, the actions and description of the single user may also apply to a plurality of users.

Conventional social networks offer users no fair value exchange. Users upload their content to the site, creating value, and receive nothing in return. Instead, the social networks seek to monetize user content. The social networking manager 205 may offer users fair value exchange in that, in exchange for the user's improvements to the social network, the user is granted ownership of the user account and retains ownership of user content added to that account, undisturbed by unwanted advertisements and malicious software.

Specifically, the social networking manager 205 may allow a user to join as a member of the social networking platform 105 and create a user account according to a payment policy. Furthermore, the social networking manager 205 may provide the user with an ad-free social networking environment (or ads limited to a user's sponsor as described below) and may allow the user to own user content associated with a user's user account stored on the social networking platform 105. Consequently, the social networking platform 105, in one embodiment, may not delete, alter, and/or modify the user content without the user's consent and/or instruction. To pay maintenance costs related to the user account, the social networking manager 205 may establish a payment policy for a use account. The payment policy may include the social networking platform 105 covering the maintenance costs, the user covering the maintenance costs, and/or associating the user account with a sponsor, which covers the maintenance costs. In one embodiment, the user chooses the sponsor. The sponsor may be a commercial entity.

In addition, the user may form associations with one or more commercial entities. Specifically, the user may associate a commercial entity with the user's user account (e.g. adding the commercial entity as a contact and/or connection). In response, the social networking manager 205 may form a communication channel between the user (e.g. the user account) and the commercial entity (e.g. the commercial entity's account). The commercial entity may send electronic messages to the user through the communication channel. In such a manner, the user may receive solicited communication from commercial entities of the user's choice. In addition, a commercial entity may reach multiple users through the social networking platform 105.

In one embodiment, a user receives rewards from receiving and/or accessing these electronic messages. The user may use the rewards for purchases with the commercial entity (or other participating commercial entities affiliated with the commercial entity). The social networking platform 105 may charge the commercial entity for the user associating with the commercial entity and/or for brokering communication with the user, including charging for the user adding the commercial entity as a contact, electronic messages sent by the commercial entity, and the like.

In addition, the social networking platform 105 may combine multiple communication environments—that include contacts/connections, content, and the like—such as a public environment, social environment, commercial environment, and the like. The social networking platform 105 may insulate each environment from one another so that, for example, a professional contact is prevented from seeing images stored as part of a user's social environment. As a result, a user may maintain contacts for the user's various aspects of life in a single social networking platform 105 instead of having multiple accounts with multiple other platforms.

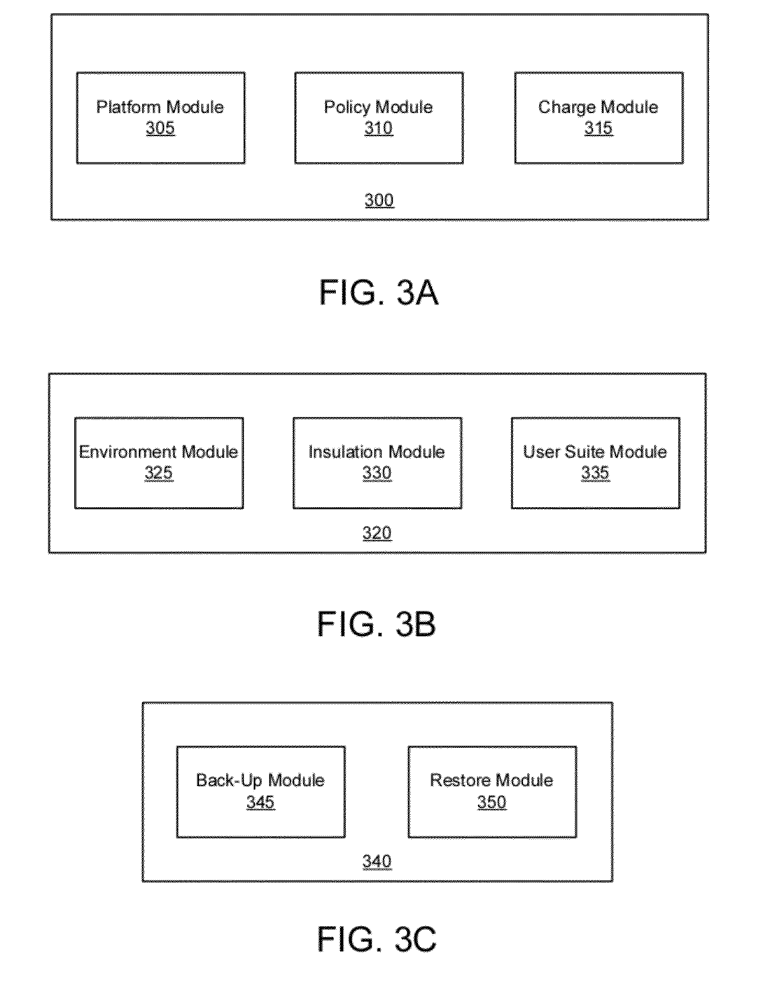

FIG. 3A depicts one embodiment of an apparatus 300 for social media communication and relationship management. Specifically, the apparatus 300 may comprise one embodiment of the social networking manager 205. The description of the apparatus 300 refers to elements of FIGS. 1-2, like numbers referring to like elements. The depicted apparatus 300 includes a platform module 305, a policy module 310, and a charge module 315.

Moreover, while the depicted embodiment includes the above listed modules, in certain embodiments, the apparatus 300 may include a subset of the depicted modules alone and/or in various combinations.

The platform module 305 provides a web-based social networking platform 105 and/or social networking website configured to allow a user to join and/or obtain a user account. The social networking platform 105 may operated by a host and may be affiliated with a plurality of independent commercial entities. Furthermore, providing the web-based social networking platform 105 may include hosting, operating, and/or otherwise facilitating the web-based social networking platform 105.

In one embodiment, the platform module 305 provides a user with a user account on the web-based social networking platform 105 free-of-charge. The user account may include an amount of allotted storage space for the user to store user content on the social networking platform 105. Furthermore, the user may own user content associated with the user account stored by the social networking platform 105. User content may include, but is not limited to user contacts, user communication channels, use media content, user messages, a user profile, user preferences, user reward points, and/or user information. In certain embodiments, the platform module 305 refrains from altering, deleting, and/or modifying user content without permission from the user. Specifically, the host operating the social networking platform 105 may form an agreement with the user, as part of the user joining the social networking platform 105, that the user content is owned by the user and that the host/social networking platform 105 will not alter, delete, or erase the user content without permission and/or instruction of the user. In one embodiment, this agreement is subject to applicable laws.

However, in one embodiment, the platform module 305 may block one or more other users from viewing the user's content. In addition, if a first user complains (e.g. files a complaint through the social networking platform 105) about user content from a second user, the platform module 305 may block the first user from viewing user content from the second user. In a further embodiment, the platform module 305 blocks additional users in the same class and/or of the same type as the first user from viewing user content of the second user. A class/type of user may include any suitable division of users such as users that are contacts of a particular user, users that are not contacts of a particular user, users in a certain geographic area, users with certain interests, and the like. For example, if a first user complains about user content from a second user and the first user is not a contact of the second user, the platform module 305 may automatically block non-contacts of the second user from viewing the second user's content.

In one embodiment, the platform module 305 brokers communication between commercial entities and the user through the social networking platform 105. The platform module 305 may broker communication by facilitating communication channel formation between the user and the one or more commercial entities. As used herein, a communication channel is an established communication path between entities on the social networking platform 105. The entities may include users (each with a corresponding user account), commercial entities (each with a corresponding commercial entity account), and the like. Furthermore, a communication channel may include one or more information channels, which are categories, types, and/or feeds that make up a particular communication channel. For example, a user may establish a communication channel with a grocery store commercial entity. The grocery store commercial entity may configure multiple information channels to which the user can subscribe to receive electronic communication/messages on various subjects: clearance items, coupons, and news. When the grocery store sends an electronic message through the information channel “news” and the user has subscribed to that information channel, the user may receive the electronic message.

In one embodiment, the platform module 305 may form a communication channel between a user and an additional user, a commercial entity, and/or other entities. The platform module 305 may also form a communication channel between a commercial entity and an additional commercial entity. Furthermore, in one embodiment, the communication channel is a two-way communication channel. Specifically, the commercial entity may communicate electronic messages to a recipient such as a non-commercial user, other commercial entity, and/or other entity. These electronic messages may be in the form of direct messages specific to the recipient, messages for multiple recipients, updates, and the like. An update may comprise a notification of an action that an entity has taken, a change in an entity's status, a post by an entity, and the like. In addition, a user may communicate information to a commercial entity through the communication channel. For example, the user (or user's account) may communicate demographic information, preferences specific to a particular commercial entity, user profile information, direct messages, and the like. For example, a user may set preferences for a commercial entity specifying that the user wants to receive updates on shoe prices. In one embodiment, a commercial entity is unable to discover certain user information such as personal information, names, and the like. Furthermore, in certain embodiments, a user is unable to send direct messages to a commercial entity and information communicated to the commercial entity is limited to certain demographic information.

Facilitating communication channel formation between the user and a commercial entity may include, besides providing a platform that allows users to create communication channels with commercial entities, presenting a representation of the commercial entity to the user in search results, suggesting that the user create a communication channel with the commercial entity, providing means by which the commercial entity may communicate with the user and invite the user to create a communication channel, and the like.

In one embodiment, the platform module 305 forms a communication channel between a user and a commercial entity in response to the user associating an indicator of the commercial entity/commercial entity's account with the user's profile. In addition, the platform module 305 may broker communication by transmitting electronic messages between entities over one or more communication channels. In one embodiment, the entities include the user and one or more commercial entities. For example, a particular commercial entity may send a message to a user over the communication channel established when the user associated the commercial entity with the user's account. In one embodiment, a user is awarded points (rewards) for establishing a communication channel with a commercial entity, receiving an electronic message from a commercial entity, accessing an electronic message from a commercial entity, and/or the like. The rewards may be redeemed with purchases from the commercial entity and/or another commercial entity with an agreement with the commercial entity.

The platform module 305 may allow an entity to compose a message and/or configure updates to be transmitted in response to certain events, and specify what contacts and/or over which communication channels for the platform module 305 to transmit the messages.

The platform module 305 may also broker communication by facilitating unsolicited communication (communication from an entity with which the user does not have an association) from one or more entities (e.g. a commercial entity) to the user. In one embodiment, a user is also rewarded for accessing the unsolicited communication. In a further embodiment, the reward for unsolicited communication is a cash reward. In one embodiment, the platform module 305 allows an entity to select a plurality of users to which to transmit unsolicited communication based on user profile information, demographic information, and the like.

In one embodiment, the platform module 305 associates the user with a particular commercial entity in response to the user requesting, through the social networking platform 105, a relationship with the particular commercial entity as described above. In one embodiment, the platform module 305 establishes the communication channel between the user and the particular commercial entity through the social networking platform 105 in response to the platform module 305 associating the user the particular commercial entity. For example, a user may, using a visual indicator of the particular commercial entity and a visual indicator of the user's network, add the commercial entity to the user's network as a contact. In this manner, the platform module 305 facilitates communication between the particular entity and the user through the communication channel.

The policy module 310 establishes a payment policy for payment of a maintenance cost of the user account. In one embodiment, the payment policy is associated with the agreement between the social networking platform 105 and/or host of the social networking platform 105 and the user, as described above, that the user content is owned by the user and that the host/social networking platform 105 will not alter, delete, or erase the user content without permission and/or instruction of the user.

In one embodiment, the user account is provided free of charge to the user according to the payment policy and the policy module 310 may establish the payment policy such that the social networking platform 105/host pays a maintenance cost of the user account on the social networking platform. In a further embodiment, the user account is maintained free of advertisements and/or malicious software. As used herein, malicious software refers to, but is not limited to, malware, spyware, and the like. In one embodiment, the policy module 310 may establish the payment policy such that the user pays a maintenance cost of the user account on the social networking platform. In this embodiment, the user account may be maintained free of advertisements and/or malicious software such as spyware. In one embodiment, the user receives a user account in exchange for “improvements” to the user account that may include the additional of user content.

In one embodiment, the policy module 310 associates the user account with a sponsor. The sponsor may pay a maintenance cost of the user account; the user account may be maintained free of additional advertisements and/or malicious software. The user may choose a sponsor from participating commercial entities. In other embodiments, maintenance fees of the user account may be covered by one or a combination of the options described above.

In one embodiment, the policy module 310 references the agreement between the user and social networking platform 105 and establishes the payment policy according to the agreement. Furthermore, the policy module 310 may associate a payment policy with a user account and/or customize a user account accordingly (e.g. configure the user account to include advertisements or vice versa). For example, a user account may have a policy identifier stored in the database associated with the user account. Web pages of the user account may be displayed according to the policy identifier (e.g. advertisements, no advertisements, or a dedicated sponsor channel).

The sponsor, in one embodiment, maintains a dedicated communication channel in association with the user account. The dedicated communication channel may be an information box, information feed, and the like that appears in association with the user account, such as on a user account home page (user suite) as described below.

The charge module 315 charges a commercial entity in response to the platform module 305 associating the user with the commercial entity. In one embodiment, the charge module 315 charges the commercial entity in response to the platform module 305 facilitating communication between the commercial entity and the user through the communication channel. In certain embodiments, the charge module 315 may charge commercial entities per communication with the user, charge commercial entities a monthly participation fee, charge commercial entities per communication channel and/or per information channel, charge commercial entities for creating a communication channel from search results, charge commercial entities for optimizing search results, and/or the like. In certain embodiments, the charge module 315 charges commercial entities in response to the platform module 305 brokering communication between the one or more commercial entities and the user through the social networking platform 105 as described above. The charge module 315 may charge a particular entity by tracking fees in association with an account of the particular entity. The charge module 315 may also bill entities by electronic and/or other suitable means.

FIG. 3B depicts one embodiment of an apparatus 320 for social media communication and relationship management. Specifically, the apparatus 320 may comprise one embodiment of the social networking manager 205. The description of the apparatus 320 refers to elements of FIGS. 1-2, like numbers referring to like elements. The depicted apparatus 320 includes an environment module 325, an insulation module 330, and a user suite module 335.

Moreover, while the depicted embodiment includes the above listed modules, in certain embodiments, the apparatus 320 may include a subset of the depicted modules alone and/or in various combinations.

The environment module 325 combines a plurality of communication environments in association with a user account on a web-based social networking platform 105. Each communication environment may include, but is not limited to including, a communication stream, a plurality of connections, a plurality of communication channels, and/or a plurality of information channels. The environment module 325 may combine communication environments, each with disparate, different, and/or distinctive user contacts from other communication environments. Moreover, each communication environment may have different features and/or characteristics depending on the type of communication environment.

Furthermore, the plurality of communication environments may include, but are not limited to a public environment, a social environment, a commercial environment, neighborhood environment, and/or a professional environment. The public environment may include a “broadcasting” environment in which a user may receive electronic messages/content from contacts that the user is “following.” The public environment may also facilitate a user broadcasting electronic messages/content to contacts (“followers”) that “follow” the user.

The social environment may include a user's social friends as contacts, allowing the exchange of electronic messages/content between the user's and the user's friends. User contacts in the social environment may be referred to as “friends.” The commercial environment may allow a user to form associations with commercial entities as described above. User contacts in the commercial environment may be referred to as “brands.” The professional environment may allow a user to form connections with professional and/or employment related contacts such as individuals, commercial entities, hiring firms, and the like. User contacts in the commercial environment may be referred to as “connections.” Certain embodiments may include other communication environments such as a neighborhood environment (contacts in a user's physical proximity) and the like. In certain embodiments, the communication environments are user configurable. For example, a user may create an environment and group connections and other content into the created environment.

The insulation module 330 insulates each communication environment from other communication environments. For example, the insulation module 330 may insulate a first communication environment of the plurality of communication environments from one or more second communication environments. In one embodiment, the insulation module 330 insulates communication environments according to user and/or default preferences. In certain embodiments, a user may add a user contact and assign the user contact to multiple communication environments.

In one embodiment, the insulation module 330, as a default setting, restricts user contacts from one communication environment from seeing user contacts (or detailed information for each user contact), content, and other information from other communication environments. In certain embodiments, the user may configure the visibility of information from one communication environment to another.

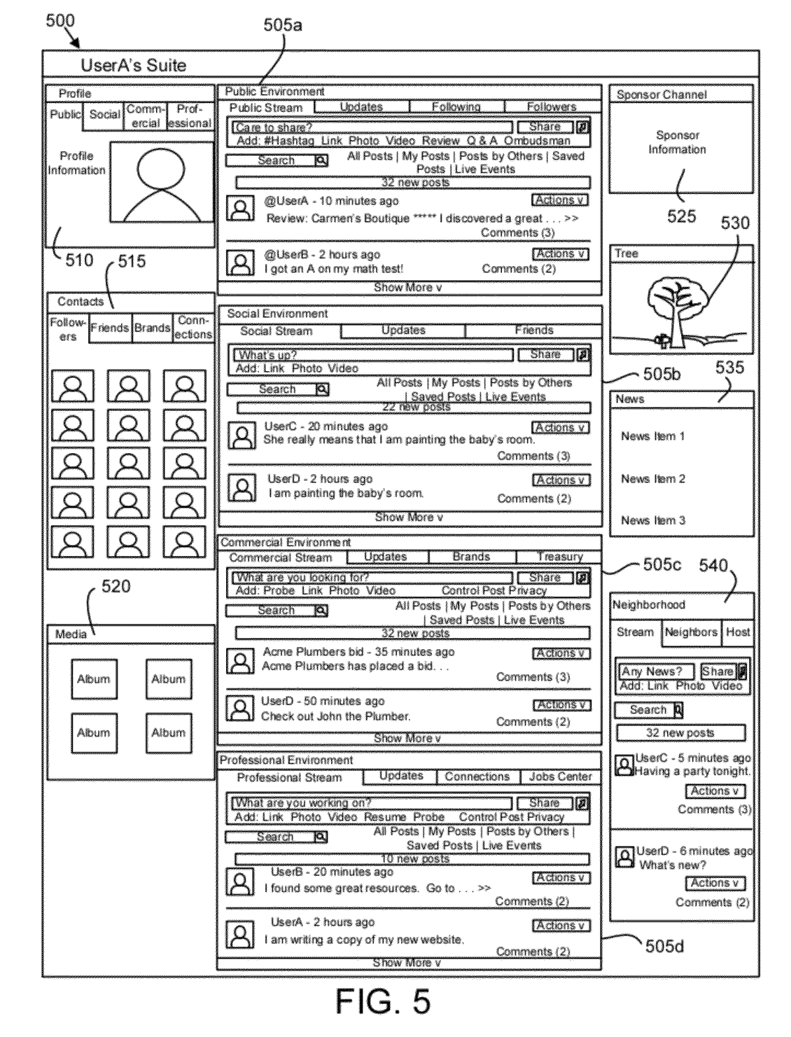

The user suite module 335 represents the plurality of communication environments on a user suite. The user suite may include a consolidated network webpage (e.g. a homepage, default loading page and/or launching page when the user logs in) on the web-based social networking platform 105 and/or social networking website for the user account. Referring also to FIG. 5, which depicts one embodiment of a user suite 500, representing the plurality of communication environments on the user suite 500 may include representing the plurality of communication environments with a plurality of environment interfaces 505. Specifically, each communication environment may be represented with a distinct environment interface 505. An environment interface 505 may include a visual representation of the communication environment including a visual representation of the communication stream, a visual representation of the plurality of connections, a visual representation of the plurality of communication channels, a visual representation of information channels, and/or any other information specific to the communication environment. The environment interface 505 may be divided into panels that each displays various aspects of the communication environment. The environment interface 505 may include a window and/or other portion of the user suite 500 designated for a specific communication environment. As depicted in FIG. 5, the user suite module 335 may aggregate a plurality of environment interfaces 505a-d on the user suite 500. The user suite module 335 may implement the one or more web pages of the user suite 500 and/or the environment interfaces 505 using images, HTML, Flash animation, scripting languages, and the like.

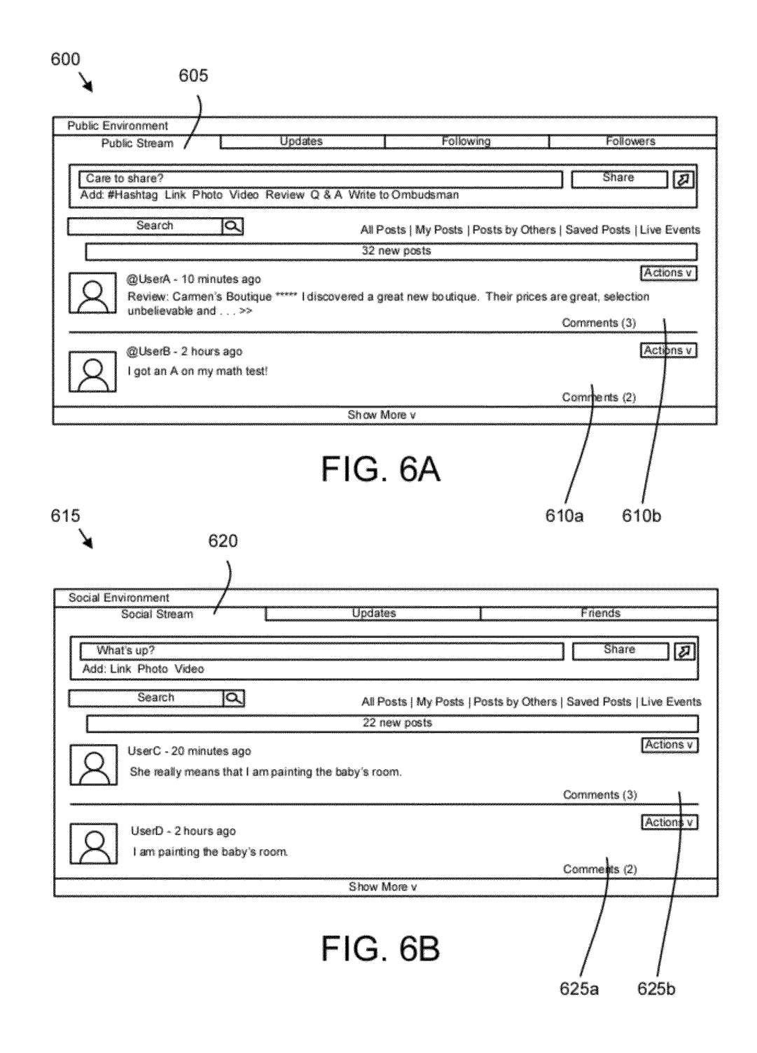

The user suite module 335 may display and/or represent electronic messages communicated through the communication channels of a particular communication environment in a particular environment interface 505 for the particular communication environment. FIG. 6A illustrates one embodiment of an environment interface 600 for a public environment. Specifically, FIG. 6A depicts a communication stream panel 605 of the user's public environment, including electronic messages 610 received through one or more communication channels of the communication environment. FIG. 6B illustrates one embodiment of an environment interface 615 for a social environment. FIG. 6B depicts a corresponding communication stream panel 620, including electronic messages 625 received from one or more social contacts. Likewise, FIG. 6C depicts an environment interface 630—showing a commercial stream panel 635—for a commercial environment and FIG. 6D depicts an environment interface 640—showing a professional stream panel 645—for a professional environment.

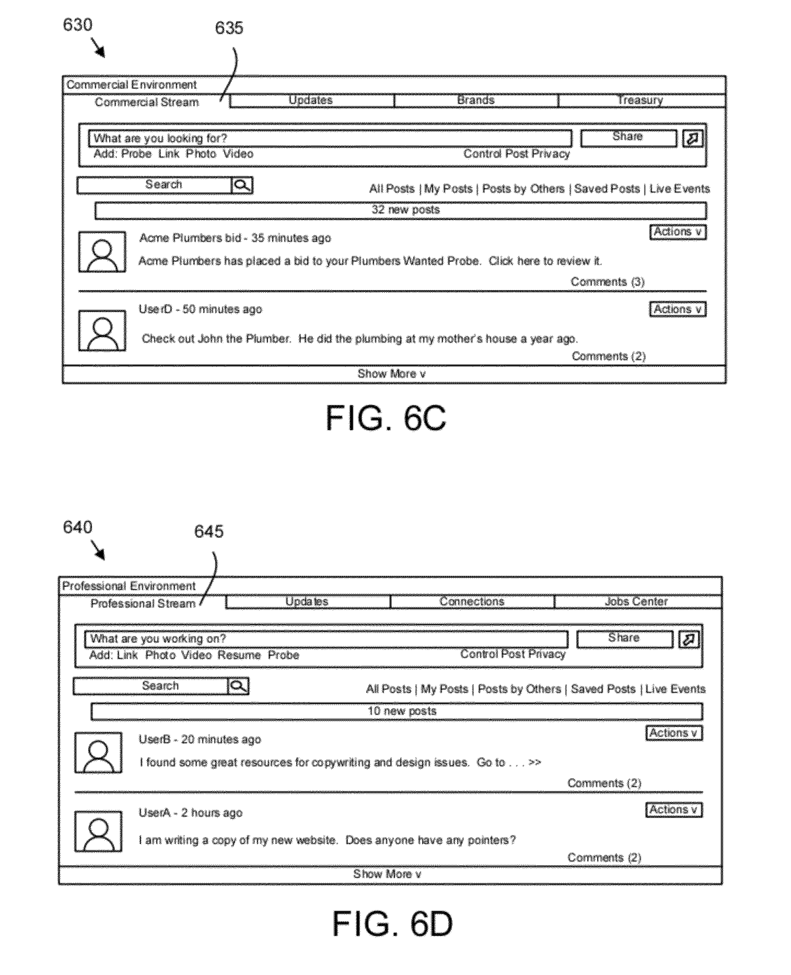

As depicted in FIG. 7A, which shows one embodiment of the environment interface 700 for the public environment, the environment interface 1100 may include other information such as “updates” 710 from user contacts in an update panel 705, user contact photos 710, user contact clusters (groups of contacts as described in greater detail in the Other application) 720, information channels 725, and the like. The environment interface 700 may sort the updates 710 (e.g. certain electronic messages) by information channel 725, by user contact photo 715, date, user contact cluster 720, and/or the like as specified by the user and/or in response to a signal from the user. Likewise, FIGS. 7B, 7C, and 7D depict embodiments of update pages for the social environment 730, the commercial environment 735, and the professional environment 740, respectively.

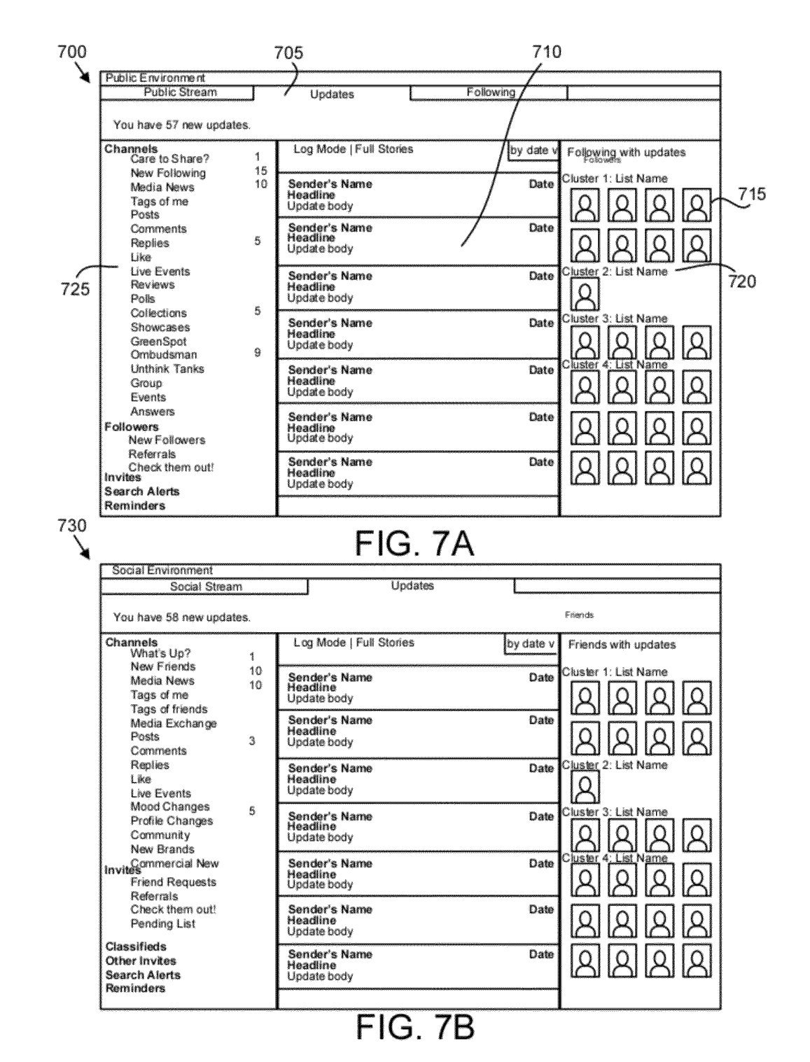

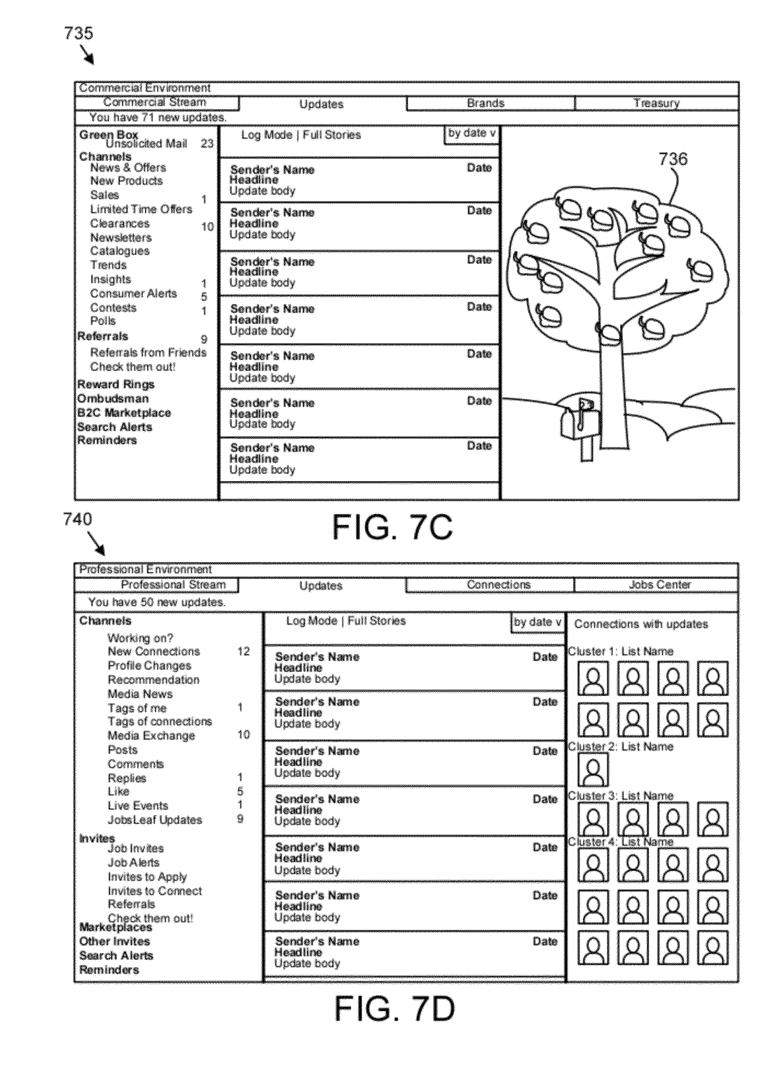

FIG. 8A shows an embodiment of the environment interface 800 for the public environment depicting the “following” panel 805 with those contacts the user is following with accompanying contact broadcast messages 810. FIG. 8B shows an embodiment of an environment interface 815 with those contacts following the user. FIG. 9A shows an embodiment of an environment interface 1300 with the user contacts (“friends”) 905 of the user in the social environment, FIG. 9B shows an embodiment of an environment interface 910 with the user contacts (“brands”) 915 of the user in the commercial environment, and FIG. 9C shows an embodiment of the environment interface 920 with the contacts (“connections”) 925 of the user in the professional environment.

As depicted in FIGS. 6-9, each environment interface may be customized based on a communication environment type. For example, in FIG. 7C, one embodiment of a commercial environment interface 735 includes a representation of an organization structure (depicted here as a tree) 736 with associated user contacts. The organizational structure 736 is described in greater detail in the Other application. Moreover, FIG. 7A depicts the user contacts as images 715 grouped in clusters 720.

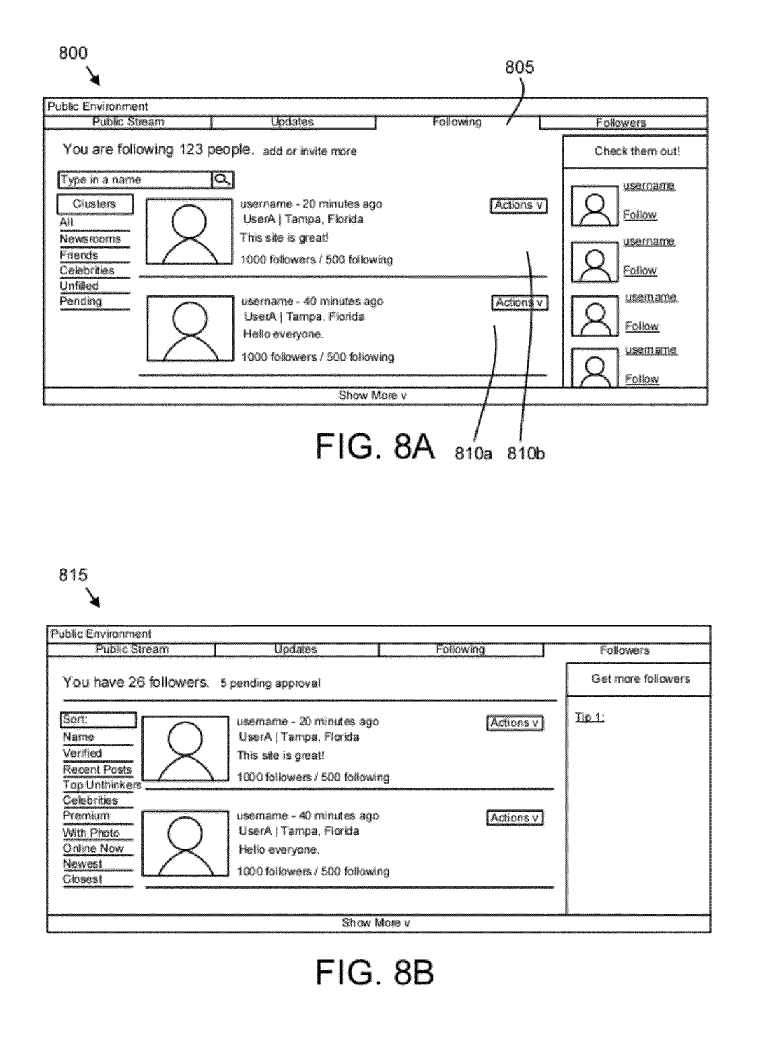

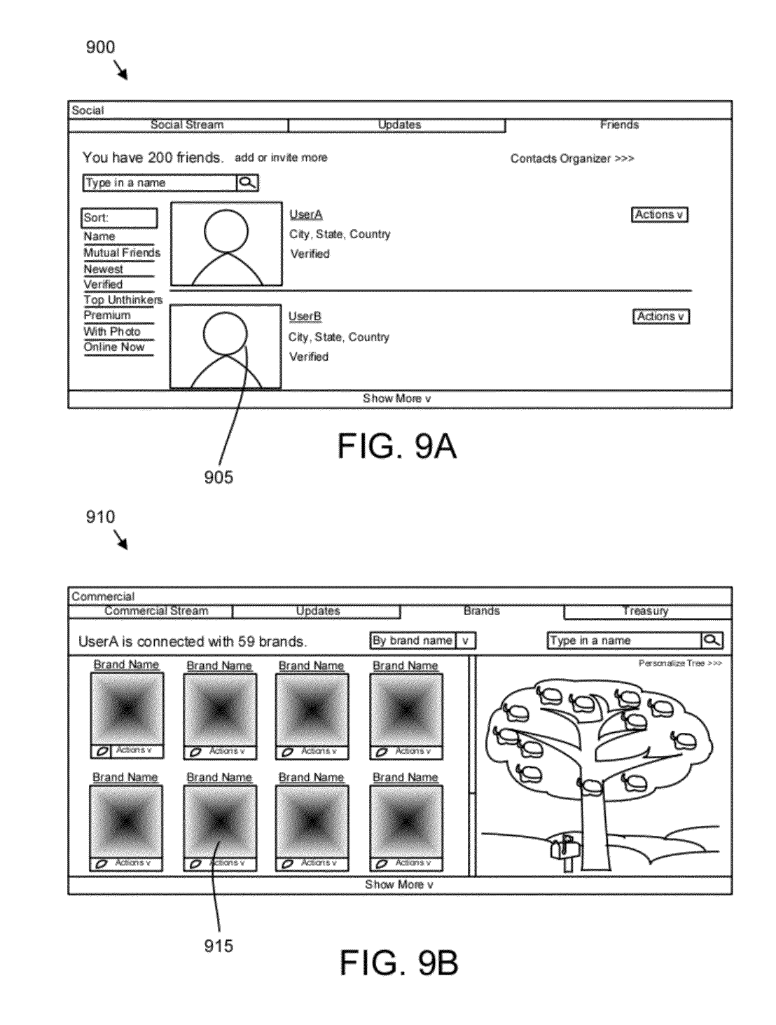

Similarly, referring now to FIG. 10, as stated above, the environment interface 1000 may also display information specific to a particular communication environment. For example, by associating with and/or establishing a communication channel with a commercial entity in the commercial environment, a user may earn rewards for electronic messages received and/or accessed by the user from the commercial entity. FIG. 10 depicts an environmental interface 1000 showing a reward statement for a user with reward information such as a commercial entity name, point balance, expiration date, and the like. Likewise, the environment interface 1100 of FIG. 11 depicts information that may be specific to the professional environment: job updates and multiple “jobsleafs” (communication channels between the user and a source of employment information).

Referring back to FIG. 3B and FIG. 5, in one embodiment, the user suite module 335 changes the appearance and/or the information that is visible of the user suite 900 based on a viewer identity. For example, the viewer identity may include the privileges associated with a viewer, the viewing rights assigned by owner of the user suite 500, and the like. In one embodiment, the viewer identity is based on a communication environment associated with the viewer. For example, if the viewer is a connection of the user's that belongs to the professional environment, the user suite module 335 may allow the viewer to view professional-related information and content on the user suite 500 while not allowing the viewer to see social content.

Along with the multiple environment interfaces 505, the user suite 500 may also include other user content such as user profile information 510, user contacts information 515, the user's media 520, a sponsor channel 525, a user's organizational structure 530, news 535, other environment interfaces 540, and the like. The user suite 500 may include more or less elements and interfaces than those depicted in FIG. 500 depending on the embodiment. The profile information 510 may include basic information about a user including location information and a photo of the user. Furthermore, in one embodiment, the profile information 510 appears differently depending on viewer identity. For example, a professional contact of a user may see the user's designated professional photo while a social contact of a user sees the user's social photo. Similarly, the contacts information 515 may also change depending of the view identity. In addition, the contacts information 515 may aggregate user contacts from various communication environments.

Likewise, different media 520 may be available for viewing depending on viewer identity. The sponsor channel 525 may be a dedicated communication channel in association with the user account as described above in relation to the policy module 310. The sponsor channel 525 may communicate information from the user's sponsor in exchange for the sponsor paying the maintenance fee of the user's account and for the social networking platform 105 maintaining an ad-free environment for the user throughout other pages of the social networking platform 105. The tree 530 may include a visual representation of user contacts (contact groupings) for one or more communication environments as described above, although any suitable visual representation may be used. Furthermore, the user suite includes a neighborhood environment interface 540 for a neighborhood communication environment that includes user contacts living in a physical proximity of the user. Other communication environments with corresponding environment interfaces may also be included. Furthermore, the user suite may include other content in various embodiments.

FIG. 3C depicts one embodiment of an apparatus 340 for social media communication and relationship management. Specifically, the apparatus 340 may comprise one embodiment of the social networking manager 205. The description of the apparatus 340 refers to elements of FIGS. 1-2, like numbers referring to like elements. The depicted apparatus 340 includes a back-up module 345 and a restore module 350.

The back-up module 345 backs-up user content stored on the social networking platform 105. In one embodiment, the back-up module 345 receives a command from the user to back-up the user content. The back-up module 345 may back-up the user content to a user storage device. User content may include, but is not limited to user contacts, user communication channels, use media content, user messages, a user profile, user preferences, user reward points, and/or user information. In one embodiment, the back-up module 345 copies user profile information and/or user content information sufficient to recreate the user profile on the social networking platform 105. In one embodiment, the back-up module 345 compresses the backed-up information into one or more archive files. Furthermore, a user storage device may include any storage device designated by the user and/or not managed by the social networking platform 105. The back-up module 345 allows a user to have greater control over the user's data stored on the social networking platform 105.

The restore module 350 uploads backed-up user content from a user. The restore module 350 may also restore user content to the user account from the backed-up user content. A user may restore user content from a personal back-up. In this manner, a user also has greater control over user content. In addition, the user may wish to restore his/her user account to a specific point in time or specific configuration, and may use the restore module 350 to restore user content from that specific point in time.

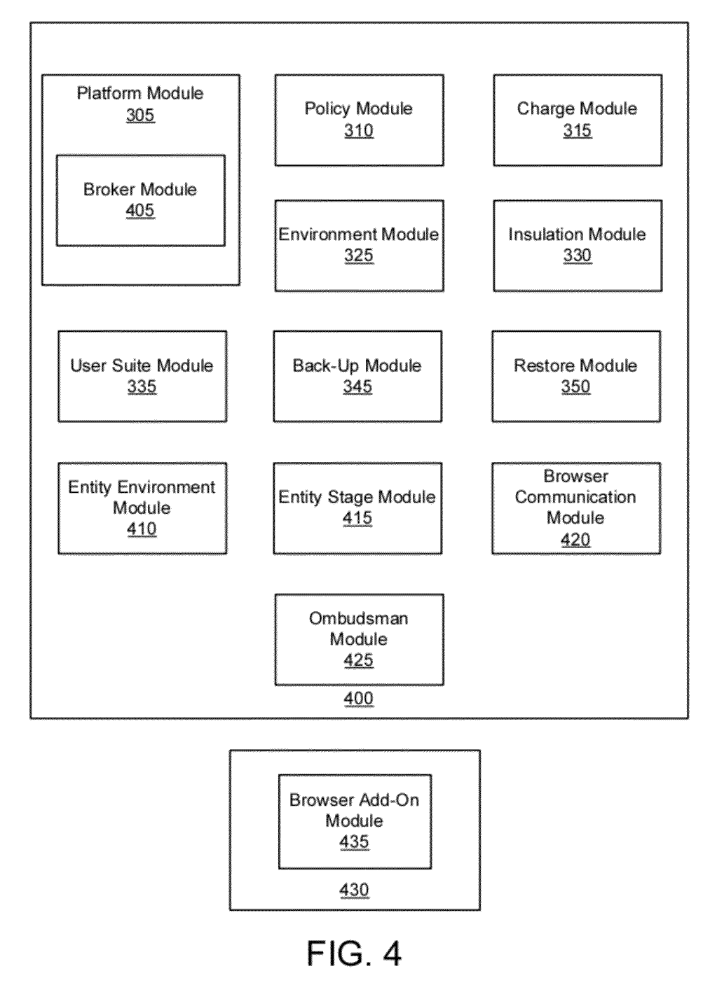

FIG. 4 depicts one embodiment of an apparatus 400 for social media communication and relationship management. Specifically, the apparatus 400 may comprise one embodiment of the social networking manager 205. The description of the apparatus 400 refers to elements of FIGS. 1-3, like numbers referring to like elements. The depicted apparatus 400 includes a platform module 305, a policy module 310, a charge module 315, an environment module 325, an insulation module 330, a user suite module 335, an entity environment module 340, a back-up module 345, and a restore module 350, wherein these modules may be substantially similar to the like-numbered modules in FIGS. 3A-3C. Furthermore, the platform module 305 includes a brokering module 405 and the apparatus 400 includes an entity environment module 410, an entity stage module 415, a browser communication module 420, and an ombudsman module 425. Additionally, a portion 430 of the apparatus 400 may reside on the client 115 and may include a browser add-on module 435. The portion 430 of the apparatus on the client 115 may comprise the browser add-on 215 depicted in FIG. 2.

Moreover, while the depicted embodiment includes the above listed modules, in certain embodiments, the apparatus 400 may include a subset of the depicted modules alone and/or in various combinations.

The broker module 405 may broker communication between entities on the social networking platform 105. Specifically, the broker module 405 may broker communication between one or more commercial entities and the user as described above in relation to the platform module 305.

The entity environment module 410 combines a plurality of communication environments in association with a commercial entity account on the web-based social networking platform 105. Each communication environment of the plurality of communication environments may include a communication stream, a plurality of commercial entity contacts, and/or a plurality of communication channels. In one embodiment, the entity environment module 340 is similar in operation to the environment module 325 except that the entity environment module 340 may combine commercial entity-specific communication environments.

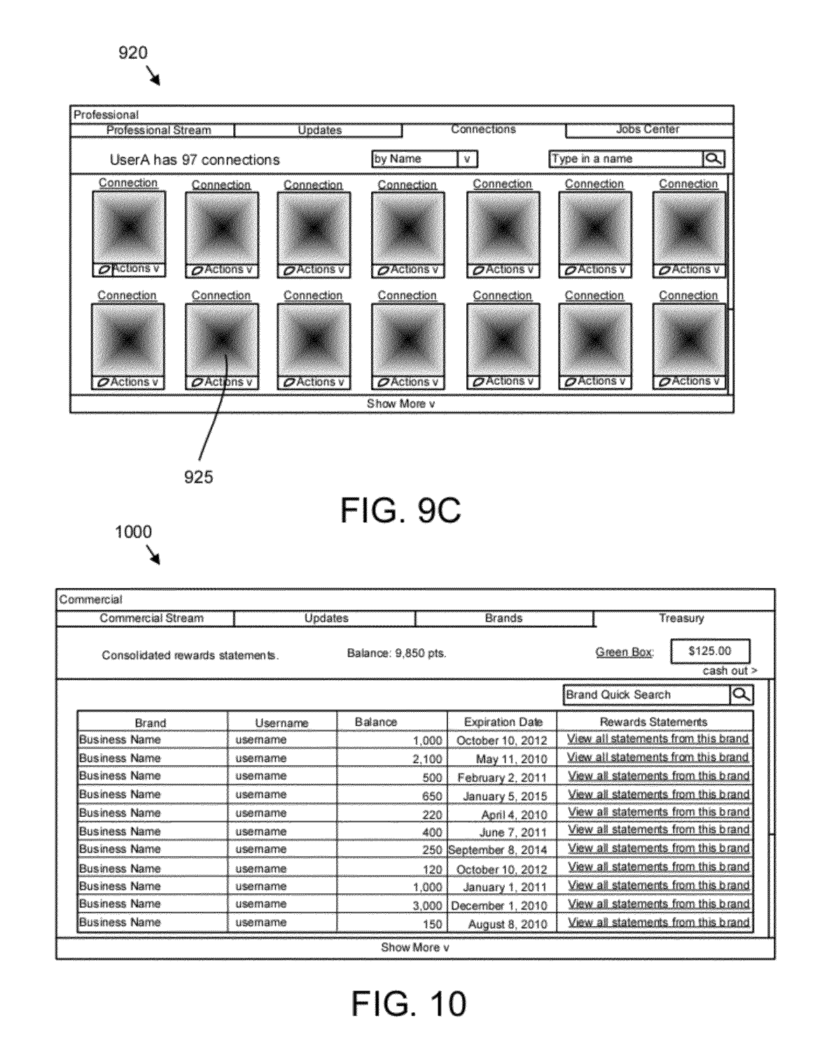

The entity stage module 345 represents the plurality of communication environments (for a commercial entity) on an entity stage. The entity stage may be similar to the user suite 500 in idea, but configured for a commercial entity. The entity stage may include a consolidated network webpage on the web-based social networking platform 105 for the commercial entity account. FIG. 12 depicts one embodiment of an entity stage 1200. The entity stage 1200 may, similar to the user suite, display communication environments for the commercial entity using environment interfaces 1205. These communication environments may include, but are not limited to, a commercial environment 1205a to send out/receive messages to/from users, a business-to-business environment 1205b to communicate with other commercial entities, a jobs environment 1205c, and the like.

The entity stage 1200 may also include, but is not limited to a commercial entity profile 1210, an ombudsman interface 1215 to manage ombudsman information as described below, user review information 1220, media 1225, sponsor information 1230 for users the commercial entity is sponsoring, rewards information 1235, subscriber lists 1240, events 1245, and other environment interfaces 1250. The entity stage 1200 may include information and/or interfaces allowing a commercial entity to establish rewards, send electronic communications, respond to ombudsman issues, set events, and the like.

Referring back to FIG. 4, the browser communication module 420 may communicate a user review notification from the social networking platform 105 to an add-on in an Internet browser of the user. The user review notification may include at least a notification of user review information and/or the user review information itself. The user review information may be entered by users of the social networking platform 105 and stored on the social networking platform 105. The networking manager 205 may save user review information for specific websites, commercial entities, and the like. For example, if a user had a good experience with a particular commercial entity, the user may enter his/her experience into the social networking manager 205, which saves the input as user review information associated with the particular commercial entity. In one embodiment, the user review information comprises ombudsman information as described below.

The browser add-on module 435 alerts the user in response to the user viewing a particular webpage on the Internet browser. The particular webpage may be associated with an entity corresponding to the user review information and/or ombudsman information (e.g. a complaint). For example, the browser add-on module may send a webpage identifier such as a Uniform Resource Locator (“URL”), company name, page metadata, and the like to the browser communication module 420. If the browser communication module 420 recognizes the webpage identifier as having associated user review information, the browser communication module 420 may signal the browser add-on module 435 that may then alert the user through a visual and/or audible means. The user may then view the user review information through the browser add-on module and/or through a link to the social networking platform 105.

The ombudsman module 425 maintains and/or manages an ombudsman service/system tracking complaints, complaint resolutions, and/or user reviews for a plurality of commercial entities on the social networking platform 105. For example, users and other entities may file complaints against commercial entities. The commercial entities may respond to the complaint or work with the complaining user/entity to resolve the complaint. The ombudsman module 425, in one embodiment, associates complaints, responses, and complaint resolutions with users and commercial entities in the social networking platform 105. Furthermore, the ombudsman module 425 may also communicate ombudsman information (e.g. complaints, resolutions, and the like) to the browser communication module 420 for communication to the browser add-on module 435 to alert a user when visiting certain websites.

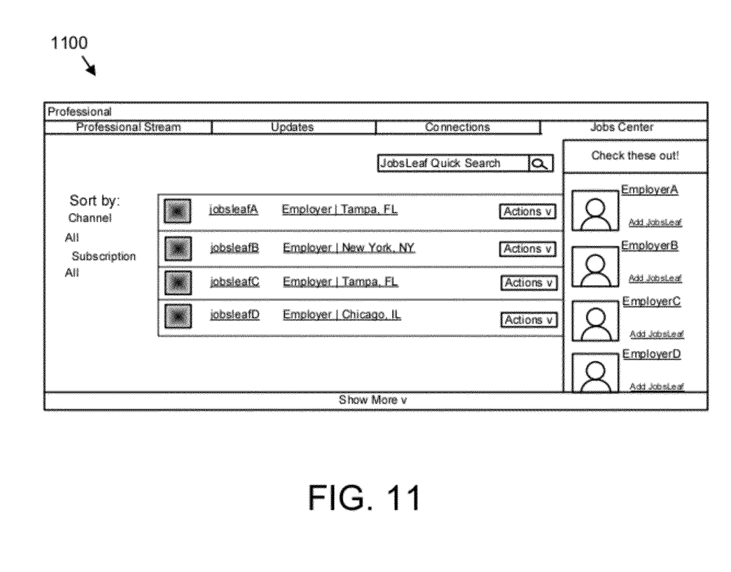

FIG. 13 depicts one embodiment of a method 1300 for social media communication and relationship management. The method 1300 may substantially include the steps to carry out at least a portion of the functions presented above with respect to the operation of the described apparatus and system of FIGS. 1-4. The description of the method 1300 refers to elements of FIGS. 1-12, like numbers referring to like elements.

In one embodiment, at least a portion of the method 1300 is implemented with a computer readable storage medium comprising a computer readable program stored on a tangible memory device and/or storage device. The computer readable storage medium may be integrated into a computer system, wherein the computer readable program executed by a processor performs at least a portion of the method 1300.

The method 1300 begins and the platform module 305 and/or social networking platform 105 provides 1305 a user with a user account on a web-based social networking platform 105. The user may own user content associated with the user account and the user content may be stored by the social networking platform 105.

The policy module 310 and/or social networking platform 105 may then establish 1310 a payment policy for payment of a maintenance cost of the user account. This may include associating the user account with a sponsor, which pays a maintenance cost of the user account and the user account is maintained free of advertisements, except for, in one embodiment, advertisements by the sponsor and/or a dedicated communication channel of the sponsor. This may include the social networking platform 105 paying the maintenance costs. This may include the user paying the maintenance cost and having the policy module 310 maintain the user's account free of advertisements. The charge module 315 and/or social networking platform 105 may then charge 1315 one or more commercial entities in response to the social networking platform 105 brokering communication between the user and one or more commercial entities. Charging one or more commercial entities in response to brokering communication may also include charging the commercial entities per communication with the user, charging commercial entities a monthly participation fee, charging commercial entities per communication channel, charging commercial entities for creating a communication channel from search results, and/or charging commercial entities for optimizing search results. Then the method 1300 ends.

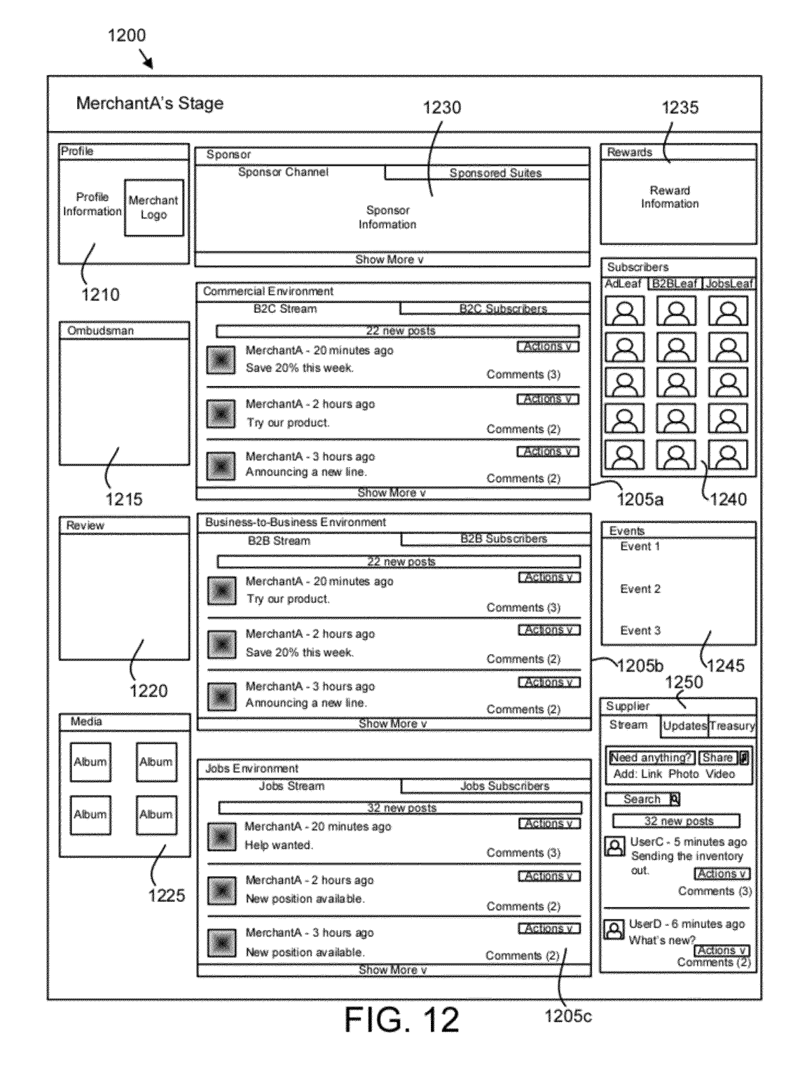

FIG. 14 depicts another embodiment of a method 1400 for social media communication and relationship management. The method 1400 may substantially include the steps to carry out at least a portion of the functions presented above with respect to the operation of the described apparatus and system of FIGS. 1-4. The description of the method 1400 refers to elements of FIGS. 1-12, like numbers referring to like elements.

In one embodiment, at least a portion of the method 1400 is implemented with a computer readable storage medium comprising a computer readable program stored on a tangible memory device and/or storage device. The computer readable storage medium may be integrated into a computer system, wherein the computer readable program executed by a processor performs at least the portion of the method 1400.

The method 1400 begins and the platform module 305 and/or social networking platform 105 provides 1405 a user with a user account on a web-based social networking platform 105 free-of-charge to the user. The user may own user content associated with the user account and the user content may be stored by the social networking platform 105.

The policy module 310 and/or social networking platform 105 may then establish 1410 a payment policy. The platform module 305/broker module 405 and/or social networking platform 105 may then form 1415 a communication channel between the user and a commercial entity. The platform module 305/broker module 405 and/or social networking platform 105 may form the communication channel in response to the user associating the user's user account with the commercial entity. Then, the platform module 305/broker module 405 and/or social networking platform 105 may transmit 1420 solicited electronic messages from the commercial entity to the user/user account. In addition, the platform module 305/broker module 405 and/or social networking platform 105 may also transmit 1425 unsolicited electronic messages to the user/user account.

The charge module 315 and/or social networking platform 105 may then charge 1430 the commercial entity in response to the platform module 305/broker module 405 communicating between the user and the commercial entity. Then the method 1400 ends.

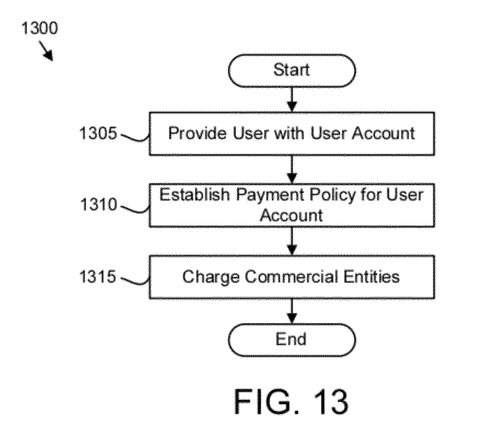

FIG. 15 depicts one embodiment of a method 1500 for social media communication and relationship management. The method 1500 may substantially include the steps to carry out at least a portion of the functions presented above with respect to the operation of the described apparatus and system of FIGS. 1-4. The description of the method 1500 refers to elements of FIGS. 1-12, like numbers referring to like elements.

In one embodiment, at least a portion of the method 1500 is implemented with a computer readable storage medium comprising a computer readable program stored on a tangible memory device and/or storage device. The computer readable storage medium may be integrated into a computer system, wherein the computer readable program executed by a processor performs the method 1500.

The method 1500 begins and the environment module 325 combines 1505 a plurality of communication environments in association with the user account on the web-based social networking platform 105. Each communication environment may include a communication stream, a plurality of connections, and/or a plurality of communication channels. The plurality of communication environments may include, but is not limited to, a social environment, a commercial environment, a public environment, and/or a professional environment.

Next, the insulation module 330 insulates 1510 a first communication environment of the plurality of communication environments from one or more second communication environments. The user suite module 335 then represents 1515 the plurality of communication environments on a user suite that may be a consolidated network webpage on the web-based social networking platform 105 for the user account. The user suite module 335 may represent a communication environment with an environment interface that includes visual representations of communication streams, connections, communication channels, and the like. Then, the method 1500 ends.

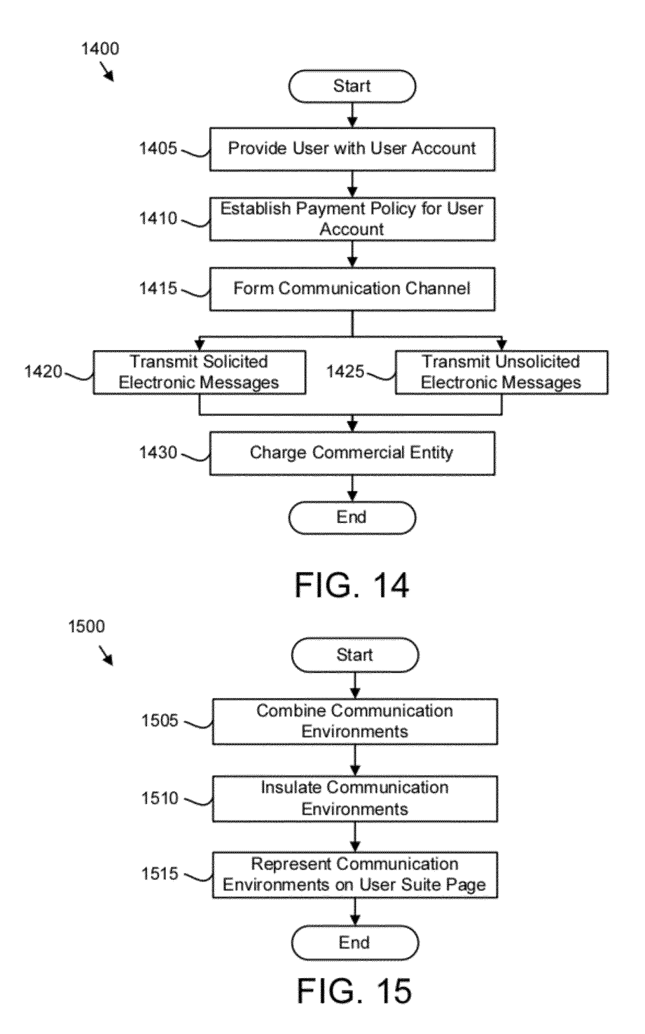

FIG. 16 depicts one embodiment of a method 1600 for social media communication and relationship management. The method 1600 may substantially include the steps to carry out at least a portion of the functions presented above with respect to the operation of the described apparatus and system of FIGS. 1-4. The description of the method 1600 refers to elements of FIGS. 1-12, like numbers referring to like elements.

In one embodiment, at least a portion of the method 1600 is implemented with a computer readable storage medium comprising a computer readable program stored on a tangible memory device and/or storage device. The computer readable storage medium may be integrated into a computer system, wherein the computer readable program executed by a processor performs the at least a portion of the method 1600.

The method 1600 begins and the environment module 325 combines 1605 a plurality of communication environments in association with the user account on the web-based social networking platform 105. Each communication environment may include a communication stream, a plurality of connections, and/or a plurality of communication channels. The plurality of communication environments may include, but is not limited to, a social environment, a commercial environment, a public environment, and/or a professional environment.

Next, the insulation module 330 insulates 1610 a first communication environment of the plurality of communication environments from one or more second communication environments. The user suite module 335 then represents 1615 the plurality of communication environments on a user suite that may be a consolidated network webpage on the web-based social networking platform 105 for the user account. The user suite module 335 may represent a communication environment with an environment interface that includes visual representations of communication streams, connections, communication channels, and the like.

The user suite module 335 then aggregates 1620 the plurality of environment interfaces on the user suite. The platform module 305 then communicates 1625 a plurality of electronic messages over a plurality of communication channels of a particular communication environment. The user suite module 335 then represents 1630 the plurality of electronic messages in a particular communication environment interface for the particular communication environment. Then, the method 1600 ends.

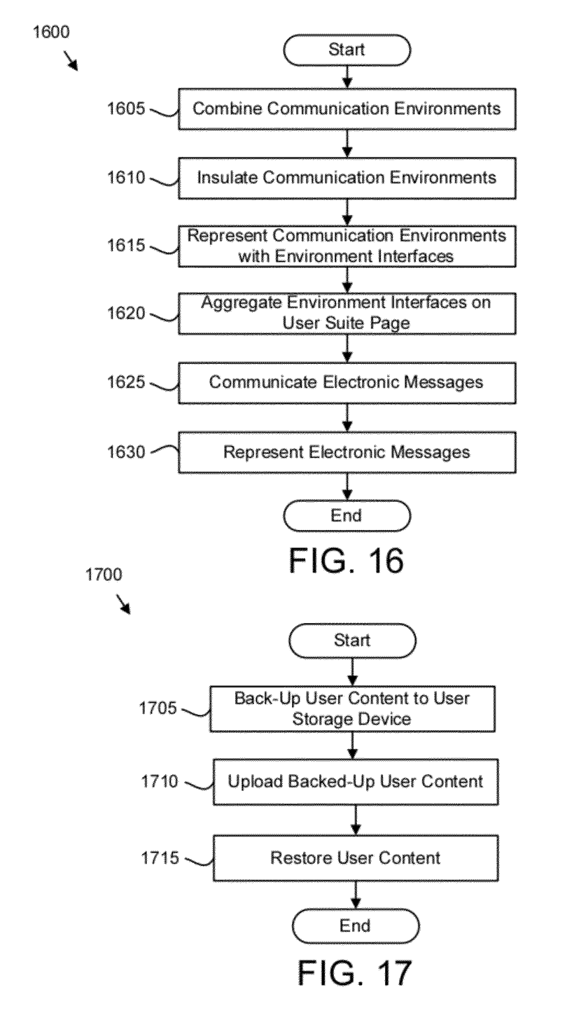

FIG. 17 depicts one embodiment of a method 700 for backing-up user content. The method 1700 may substantially include the steps to carry out at least a portion of the functions presented above with respect to the operation of the described apparatus and system of FIGS. 1-4. The description of the method 1700 refers to elements of FIGS. 1-12, like numbers referring to like elements. In one embodiment, at least a portion of the method 1700 is implemented with a computer readable storage medium comprising a computer readable program stored on a tangible memory device and/or storage device. The computer readable storage medium may be integrated into a computer system, wherein the computer readable program executed by a processor performs the at least a portion of the method 1700.

The method 1700 begins and the back-up module 345 back-ups 1705 user content to a user storage device. The back-up may occur in response to a command from a user or at a predetermined time interval. The user storage device may be a device under the user's control, not under the control of the host, platform module 305, and/or social networking platform 105. Next, the restore module 350 uploads 1710 backed-up user content from a user and/or user storage device. Then the restore module 350 restores 1715 user content to the user account from the backed-up user content. Then, the method 1700 ends.

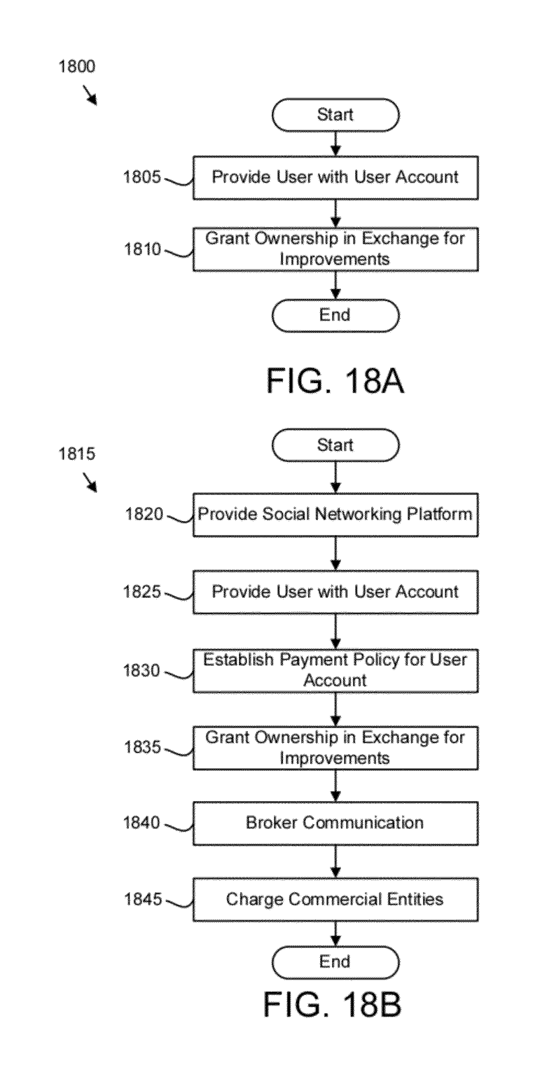

FIG. 18A depicts another embodiment of a method 1800 for social media communication and relationship management. The description of the method 1800 refers to elements of FIGS. 1-12, like numbers referring to like elements. In one embodiment, the method 1800 may be performed by the social networking platform 105 and/or a social networking provider that hosts, supports, operates, and/or provides a social networking platform such as the social networking platform 105 and/or a social networking website such as the social networking website described above.

The method 1800 begins and includes providing 1805 a user with a user account on the social networking platform 105. The user account may include a portion of the social networking platform 105. In one embodiment, the portion of the social networking platform 105 (and/or user account) may include capacity to store user content on the social networking platform 105, a Uniform Resource Locator (“URL”) on the social networking platform 105 associated with the user account, a user suite page as described above, and the like.

Next, the method includes granting 1810 ownership of the user account and/or the associated user content to the user in exchange for the user improving the social networking platform 105 and/or the user account. Then, the method 1800 ends. In one embodiment, granting ownership in exchange for the user improving the social networking platform 105/user account further includes entering into an agreement with the user to receive the user's improvements in exchange for allowing the user ownership, use, possession, enjoyment of the user's user account, and/or user content. The social networking platform 105/social networking provider may agree, as described above, to refrain from altering, denying access to, and/or deleting user content subject to applicable laws. In certain embodiments, the social networking platform 105/social networking provider may agree to a certain level of privacy (e.g. insulating a user's communication environments, default privacy settings, user configurable privacy settings, and the like as described above). In one embodiment, improving the user account and/or social networking platform 105 may include adding contacts, adding user content, inviting others to join the social networking platform 105, and the like.

FIG. 18B depicts another embodiment of a method 1815 for social media communication and relationship management. The description of the method 1815 refers to elements of FIGS. 1-12, like numbers referring to like elements. The method 1815 may be performed by the social networking platform 105 and/or a social networking provider that hosts, supports, operates, and/or provides a social networking platform such as the social networking platform 105 and/or a social networking website such as the social networking website described above.

The method 1815 begins with providing 1820 asocial networking platform. In one embodiment, the social networking platform is similar to the social networking platform 105 described above. Next, the method 1815 includes providing 1820 a user with a user account on the social networking platform 105. The user account may include a portion of the social networking platform 105. In one embodiment, the portion of the social networking platform 105 (and/or user account) may include capacity to store user content on the social networking platform 105, a URL on the social networking platform 105 associated with the user account, a user suite page as described above, and the like.

Next, the method 1815 includes establishing 1830 a payment policy for the user account. In one embodiment, the user account is provided free of charge to the user, and providing the user with the user account further includes associating the user account with a sponsor. The sponsor may pay a maintenance cost of the user account on the social networking platform 105 and the user account may be maintained free of one or more of additional advertisements and malicious software. In one embodiment, the user account is provided free of charge to the user, and providing the user with the user account further includes paying at least a portion of a maintenance cost of the user account on the social networking platform 105. In this embodiment, the user account may be maintained free of one or more of advertisements and malicious software. In one embodiment, the user pays a maintenance cost of the user account on the social networking platform 105 and providing the user with the user account further includes maintaining the user account free of one or more of advertisements and malicious software.

Next, the method 1815 includes granting 1835 ownership of the user account and/or the associated user content to the user in exchange for the user improving the social networking platform 105 and/or the user account. In one embodiment, granting ownership in exchange for the user improving the social networking platform 105/user account further includes the social networking platform 105 entering into an agreement with the user to receive the user's improvements in exchange for allowing the user ownership, use, possession, enjoyment of the user's user account, and/or user content. The social networking platform 105 may agree, as described above, to refrain from altering, denying access to, and/or deleting user content subject to applicable laws. In certain embodiments, the social networking platform 105 may agree to a certain level of privacy (e.g. insulating a user's communication environments, default privacy settings, user configurable privacy settings, and the like as described above). Next, the method 1815 includes brokering communication between one or more commercial entities and the user through the social networking platform 105 as described above. The method 1815 then includes charging 1845 the one or more commercial entities according to the brokered communication and the method 1815 ends.

The subject matter described herein may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
providing a user with a user account on a web-based social networking platform, wherein the user owns user content associated with the user account, the user content stored by the social networking platform; and
charging one or more commercial entities in response to brokering communication between the one or more commercial entities and the user through the social networking platform.

2. The method of claim 1, wherein the user account is provided free of charge to the user, the method further comprising establishing a payment policy comprising associating the user account with a sponsor, wherein the sponsor pays a maintenance cost of the user account on the social networking platform and the user account is maintained free of one or more of additional advertisements and malicious software.

3. The method of claim 1, wherein the user account is provided free of charge to the user, the method further comprising establishing a payment policy wherein the social networking platform pays a maintenance cost of the user account on the social networking platform, the user account maintained free of one or more of advertisements and malicious software.

4. The method of claim 1, the method further comprising establishing a payment policy wherein the user pays a maintenance cost of the user account on the social networking platform, the user account maintained free of one or more of advertisements and malicious software.

5. The method of claim 1, further comprising brokering communication between the one or more commercial entities and the user through the social networking platform wherein brokering communication further comprises:
facilitating communication channel formation between the user and the one or more commercial entities;
transmitting electronic messages between the user and the one or more commercial entities over one or more communication channels; and
facilitating unsolicited communication from the one or more commercial entities to the user.

6. The method of claim 1, wherein charging one or more commercial entities in response to brokering communication further comprises one or more of charging commercial entities per communication with the user, charging commercial entities a monthly participation fee, charging commercial entities per communication channel, charging commercial entities for creating a communication channel from search results, and charging commercial entities for optimizing search results.

7. The method of claim 1, further comprising managing an ombudsman service tracking one or more of complaints, complaint resolutions, and user reviews for a plurality of commercial entities on the social networking platform.

8. The method of claim 1, further comprising:
combining a plurality of communication environments in association with the user account on the web-based social networking platform, each communication environment comprising a communication stream, a plurality of user contacts, and a plurality of communication channels;
insulating a first communication environment of the plurality of communication environments from one or more second communication environments; and
representing the plurality of communication environments on a user suite, the user suite comprising a consolidated network webpage on the web-based social networking platform for the user account.

9. The method of claim 8, wherein representing the plurality of communication environments on the user suite further comprises representing the plurality of communication environments with a plurality of environment interfaces, wherein each communication environment is represented with a distinct environment interface, and wherein representing the plurality of communication environments further comprises aggregating the plurality of environment interfaces on the user suite.

10. The method of claim 9, wherein a particular environment interface comprises a first visual representation of the communication stream, a second visual representation of the plurality of user contacts, and a third visual representation of the plurality of communication channels.

11. The method of claim 9, further comprising:
communicating a plurality of electronic messages over the plurality of communication channels of a particular communication environment;
representing the plurality of electronic messages in a particular environment interface for the particular communication environment; and
sorting the plurality of represented electronic messages by one or more of communication channel, date, and user contact photo as specified by the user.

12. The method of claim 8, further comprising:
combining a second plurality of communication environments in association with a commercial entity account on the web-based social networking platform, each communication environment of the second plurality of communication environments comprising a communication stream, a plurality of commercial entity contacts, and a plurality of communication channels; and
representing the second plurality of communication environments on a commercial entity stage, the commercial entity stage comprising a consolidated network webpage on the web-based social networking platform for the commercial entity account.

13. The method of claim 1, further comprising communicating a user review notification from the social networking platform to an add-on in an Internet browser of the user, the user review notification comprising at least a notification of user review information, the add-on configured to alert the user in response to the user viewing a particular webpage on the Internet browser, the particular webpage associated with an entity corresponding to the user review information, the user review information stored on the social networking platform.

14. The method of claim 1, further comprising:
backing-up the user content stored on the social networking platform to a user storage device;
uploading backed-up user content from the user storage device; and
restoring user content to the user account from the backed-up user content.

15. An apparatus comprising:
a platform module configured to provide a user with a user account on a web-based social networking platform free-of-charge for the user, wherein the user owns user content associated with the user account, the user content stored by the social networking platform;
a policy module configured to establish a payment policy for payment of a maintenance cost of the user account;
a broker module configured to broker communication between one or more commercial entities and the user through the social networking platform; and
a charge module configured to charge the one or more commercial entities in response to the broker module brokering communication between the one or more commercial entities and the user through the social networking platform.

16. The apparatus of claim 15, wherein the broker module is further configured to:
facilitate communication channel formation between the user and the one or more commercial entities;
transmit electronic messages between the user and the one or more commercial entities over one or more communication channels; and
facilitate unsolicited communication from the one or more commercial entities to the user.

17. The apparatus of claim 15, further comprising:
an environment module configured to combine a plurality of communication environments in association with the user account on the web-based social networking platform, each communication environment comprising a communication stream, a plurality of connections, and a plurality of communication channels, wherein the plurality of communication environments comprises a social environment, a commercial environment, a public environment, and a professional environment;
an insulation module configured to insulate a first communication environment of the plurality of communication environments from one or more second communication environments; and
a user suite module configured to represent the plurality of communication environments on a user suite, the user suite comprising a consolidated network webpage on the web-based social networking platform for the user account.

18. The apparatus of claim 17, further comprising:
an entity environment module configure to combine a second plurality of communication environments in association with a commercial entity account on the web-based social networking platform, each communication environment of the second plurality of communication environments comprising a communication stream, a plurality of commercial entity contacts, and a plurality of communication channels; and
an entity stage module configured to represent the second plurality of communication environments on a commercial entity stage, the commercial entity stage comprising a consolidated network webpage on the web-based social networking platform for the commercial entity account.

19. A computer program product comprising a computer readable storage medium having computer readable program code embodied therewith, the computer readable program code configured to:
provide a user with a user account on a web-based social networking platform free-of-charge to the user, wherein the user owns user content associated with the user account, the user content stored by the social networking platform;
establish a payment policy for payment of a maintenance cost of the user account; and
charge one or more commercial entities in response to brokering communication between the one or more commercial entities and the user through the social networking platform.

20. The computer program product of claim 19, the computer readable program code further configured to:
combine a plurality of communication environments in association with the user account on the web-based social networking platform, each communication environment comprising a communication stream, a plurality of user contacts, and a plurality of communication channels, wherein the plurality of communication environments comprises a social environment, a commercial environment, a public environment, and a professional environment;
insulate a first communication environment of the plurality of communication environments from one or more second communication environments; and
represent the plurality of communication environments on a user suite, the user suite comprising a consolidated network webpage on the web-based social networking platform for the user account.

21. A method comprising:
providing a user with a user account on a web-based social networking platform, the user account comprising a portion of the social networking platform, the user account comprising capacity to store user content on the social networking platform; and
granting ownership of the user account and associated user content to the user in exchange for the user improving the social networking platform.

22. The method of claim 21, wherein the user account is provided free of charge to the user, the method further comprising associating the user account with a sponsor, wherein the sponsor pays a maintenance cost of the user account on the social networking platform and the user account is maintained free of one or more of additional advertisements and malicious software.

23. The method of claim 21, wherein the user account is provided free of charge to the user, the method further comprising paying at least a portion of a maintenance cost of the user account on the social networking platform, the user account maintained free of one or more of advertisements and malicious software.

24. The method of claim 21, wherein the user pays a maintenance cost of the user account on the social networking platform, the user account maintained free of one or more of advertisements and malicious software.

25. The method of claim 21, further comprising charging one or more commercial entities in response to brokering communication between the one or more commercial entities and the user through the social networking platform.
